(19) United States
(12) Patent Application Publication
(10) Pub. No.: US 2025/0232258 A1
(43) Pub. Date: Jul. 17, 2025

(54) SYSTEMS AND METHODS FOR ML-ASSISTED GENERATION OF PROJECT INITIATION DOCUMENTS

(71) Applicant: Klick Inc., Toronto (CA)

(72) Inventor: Aaron Hersh Goldstein, Toronto (CA)

(21) Appl. No.: 19/020,159

(22) Filed: Jan. 14, 2025

Related U.S. Application Data
(60) Provisional application No. 63/620,952, filed on Jan. 15, 2024.

(51) Int. Cl. G06Q 10/10; G06Q 10/0633

(52) U.S. Cl. CPC G06Q 10/103; G06Q 10/0633

(57) ABSTRACT

Provided are computer-implemented systems and methods for generating an ML-assisted project initiation user interface, comprising: providing, at a memory, a persona database comprising a plurality of personas and a corresponding plurality of questions; sending, at a network device, an ML-assisted project initiation user interface to a user device; receiving, at a network device, document content from a user at the user device; generating, at a processor in communication with the memory and the network device, an assessment of the document content; sending, using the network device, the assessment to a Large Language Model (LLM) system; receiving, using the network device, an assessment response from the LLM system corresponding to the assessment; updating, at the processor, the ML-assisted project initiation user interface with at least one unanswered question based on the assessment response.

### CROSS-REFERENCE TO RELATED APPLICATION

This application claims the benefit of U.S. Provisional Application No. 63/620,952 filed on Jan. 15, 2024, which is incorporated by reference herein in its entirety.

### FIELD

The present disclosure relates to systems and methods for providing AI and ML-assisted workflows, and in particular systems and methods for ML-assisted workflows to streamline the generation of project initiation documents using Large Language Models (LLMs).

### BACKGROUND

The following is not an admission that anything discussed below is part of the prior art or part of the common general knowledge of a person skilled in the art.

Project initiation, including for companies that work on an agency model for marketing, software development, legal, or other fields involves a lot of stakeholder input. Stakeholder input may be provided in a variety of ways, but commonly, it is provided by way of meetings that are held with various stakeholders. These meetings require many different potential stakeholders who may contribute to a project initiation document. This can be a very time consuming process. Conventional solutions relate to workflow tools that allow human users to review a proposal and provide feedback, which is incorporated by the author.

### SUMMARY

The following summary is intended to introduce the reader to various aspects of the detailed description, but not to define or delimit any invention. One or more inventions may reside in any combination or sub-combination of the elements or process steps disclosed in any part of this document including its claims and figures.

The present disclosure is directed to an ML-assisted application that facilitates the collection of project initiation data. In particular, the systems and methods described herein enable the intake of partial or full requirements for a project using an iterative posed question and classification approach to assist a user in defining requirements for successful project and program delivery.

The application can prompt the user to input project initiation data by presenting prompt questions in a user interface that are identified and selected based on information provided by the user through the user interface. The questions selected may be dependent upon the context of the data provided by the user, such as the specific client or project type being initiated. For example, if the user is indicating that a project to-be initiated is a website, the questions may selected based on contextually awareness of considerations that are typically required for website creation. The selected questions can also reflect different stakeholders needs (creative, technology, user experience, analytics etc.).

The selected questions can also be presented in a contextual manner such that particular questions are only displayed in the user interface when appropriate. This may facilitate user engagement and provide a streamlined data gathering process. The systems and methods described herein may also omit questions where the collected project initiation data provides an answer to the questions, in some cases determined through inferences made by an LLM system.

In an aspect of this disclosure, there is provided a computer-implemented method for generating an ML-assisted project initiation user interface using a plurality of personas and a corresponding plurality of questions, comprising: transmitting, to a user device, ML-assisted project initiation user interface data usable at the user device to render a ML-assisted project initiation user interface, the ML-assisted project initiation user interface defined to include at least one virtual representative, each virtual representative corresponding to one of the personas in the plurality of personas and each virtual representative associated with at least one associated question from the plurality of questions; receiving collected project initiation data from a user at the user device through the ML-assisted project initiation user interface, wherein the collected project initiation data is received subsequent to presenting a question prompt to the user through the ML-assisted project initiation user interface, wherein the question prompt includes a particular virtual representative and a particular associated question associated with that particular virtual representative; transmitting an assessment prompt to a Large Language Model (LLM) system, wherein the assessment prompt includes at least one selected question from the plurality of questions and the collected project initiation data received from the user; receiving, an assessment response from the LLM system in response to the assessment prompt, wherein the assessment response indicates whether the collected project initiation data is responsive to the at least one selected question; updating, at the processor, the ML-assisted project initiation user interface with at least one unanswered question from the plurality of questions based on the assessment response.

The method can include selecting the plurality of questions from the persona database based on a selected set of personas and a priority metric associated with each question in the plurality of questions.

The method can include identifying, at the processor, a sub-grouping of related questions based on the assessment response, the sub-grouping of related questions being related to a particular selected question of the at least one selected question, wherein the assessment response indicates that further related project initiation data is required relating to the particular selected question and the sub-grouping of related questions is identified to prompt the collected of the further related project initiation data; and updating, at the processor, the ML-assisted project initiation user interface with the sub-grouping of questions.

The document content can include text.

The document content can include image data and the Large Language Model (LLM) system comprises a multi-modal model.

The method can include identifying at least two candidate Large Language Model (LLM) systems; and selecting the Large Language Model (LLM) system from the at least two candidate LLM systems.

The method can include receiving, from the user device, a persona selection request comprising the selected plurality of personas.

In accordance with this aspect, there is provided a computer-implemented system for generating an ML-assisted project initiation user interface, comprising: a memory storing a plurality of personas and a corresponding plurality of questions; a processor in communication with the memory and a user device, the processor configured to: transmit, to a user device, ML-assisted project initiation user interface data usable at the user device to render a ML-assisted project initiation user interface, the ML-assisted project initiation user interface defined to include at least one virtual representative, each virtual representative corresponding to one of the personas in the plurality of personas and each virtual representative associated with at least one associated question from the plurality of questions; receive collected project initiation data from a user at the user device through the ML-assisted project initiation user interface, wherein the collected project initiation data is received subsequent to presenting a question prompt to the user through the ML-assisted project initiation user interface, wherein the question prompt includes a particular virtual representative and a particular associated question associated with that particular virtual representative; send an assessment prompt to a Large Language Model (LLM) system, wherein the assessment prompt includes at least one selected question from the plurality of questions and the collected project initiation data received from the user; receive an assessment response from the LLM system in response to the assessment prompt, wherein the assessment response indicates whether the collected project initiation data is responsive to the at least one selected question; and update the ML-assisted project initiation user interface with at least one unanswered question from the plurality of questions based on the assessment response.

The processor can be further configured to: select the plurality of questions from the persona database based on a selected set of personas and a priority metric associated with each question in the plurality of questions.

The processor can be further configured to: identify a sub-grouping of related questions based on the assessment response, the sub-grouping of related questions being related to a particular selected question of the at least one selected question, wherein the assessment response indicates that further related project initiation data is required relating to the particular selected question and the sub-grouping of related questions is identified to prompt the collected of the further related project initiation data; and update the ML-assisted project initiation user interface with sub-grouping of questions.

The document content can include text.

The document content can include image data and the Large Language Model (LLM) system comprises a multi-modal model.

The processor can be configured to: identify at least two candidate Large Language Model (LLM) systems; and select the Large Language Model (LLM) system from the at least two candidate LLM systems.

The processor can be configured to: receive, a persona selection request comprising the selected plurality of personas.

In accordance with this aspect of the disclosure, there is provided a computer program product for generating an ML-assisted project initiation user interface, the computer program product comprising a non-transitory computer readable medium storing computer-executable instructions wherein when the computer-executable instructions are executed by a processor the instructions cause the processor to perform a method for generating an ML-assisted project initiation user interface using a plurality of personas and a corresponding plurality of questions, wherein the method comprises: transmitting, to a user device, ML-assisted project initiation user interface data usable at the user device to render a ML-assisted project initiation user interface, the ML-assisted project initiation user interface defined to include at least one virtual representative, each virtual representative corresponding to one of the personas in the plurality of personas and each virtual representative associated with at least one associated question from the plurality of questions; receiving collected project initiation data from a user at the user device through the ML-assisted project initiation user interface, wherein the collected project initiation data is received subsequent to presenting a question prompt to the user through the ML-assisted project initiation user interface, wherein the question prompt includes a particular virtual representative and a particular associated question associated with that particular virtual representative; transmitting an assessment prompt to a Large Language Model (LLM) system, wherein the assessment prompt includes at least one selected question from the plurality of questions and the collected project initiation data received from the user; receiving, an assessment response from the LLM system in response to the assessment prompt, wherein the assessment response indicates whether the collected project initiation data is responsive to the at least one selected question; updating, at the processor, the ML-assisted project initiation user interface with at least one unanswered question from the plurality of questions based on the assessment response.

The computer program product can include instructions for configuring a processor to select the plurality of questions from the persona database based on a selected set of personas and a priority metric associated with each question in the plurality of questions.

The computer program product can include instructions for configuring a processor to identify a sub-grouping of related questions based on the assessment response, the sub-grouping of related questions being related to a particular selected question of the at least one selected question, wherein the assessment response indicates that further related project initiation data is required relating to the particular selected question and the sub-grouping of related questions is identified to prompt the collected of the further related project initiation data; and update the ML-assisted project initiation user interface with sub-grouping of questions.

The computer program product can include instructions for configuring a processor to identify at least two candidate Large Language Model (LLM) systems; and select the Large Language Model (LLM) system from the at least two candidate LLM systems.

The computer program product can include instructions for configuring a processor to receive, a persona selection request comprising the selected plurality of personas.

In a further aspect of this disclosure, there is provided a computer-implemented method for generating an ML-assisted project initiation user interface, comprising: providing, at a memory, a persona database comprising a plurality of personas and a corresponding plurality of questions; sending, at a network device, an ML-assisted project initiation user interface to a user device; receiving, at the network device, document content from a user at the user device; generating, at a processor in communication with the memory and the network device, an assessment of the document content; sending, using the network device, the assessment to a Large Language Model (LLM) system; receiving, using the network device, an assessment response from the LLM system corresponding to the assessment; updating, at the processor, the ML-assisted project initiation user interface with at least one unanswered question based on the assessment response.

The method may further include: updating, at the processor, the selected plurality of questions from the selected plurality of personas by filtering the questions based on a priority metric.

The method may further include: identifying, at the processor, at least one sub-grouping of questions based on the assessment response, the at least one sub-grouping of questions at a different priority metric from the selected plurality of questions; and updating, at the processor, the ML-assisted project initiation user interface with at least one sub-grouping of questions.

The method may further include: providing, at the memory, a client database comprising at least one client fact, each client fact corresponding to a client identifier; receiving, at the processor, a client selection request comprising a selected client identifier; and wherein the assessment of the document content may comprise the at least one client fact in the client database corresponding to the selected client identifier.

The document content may comprise text.

The document content may comprise image data and the Large Language Model (LLM) system comprises a multi-modal model.

The method may further include: identifying at least two candidate Large Language Model (LLM) systems; and selecting the Large Language Model (LLM) system from the at least two candidate LLM systems.

The method may further include: receiving, at the network device, a persona selection request comprising the selected plurality of personas; and wherein the assessment of the document content may comprise a selected plurality of questions from the selected plurality of personas.

In a further aspect of this disclosure, there is provided a computer-implemented system for generating an ML-assisted project initiation user interface, comprising: a memory comprising a persona database comprising a plurality of personas and a corresponding plurality of questions; a network device; and a processor in communication with the memory and the network device, the processor configured to: sending, using the network device, an ML-assisted project initiation user interface to a user device; receive, using the network device, document content from a user at the user device; generate an assessment of the document content; send, using the network device, the assessment to a Large Language Model (LLM) system; receive, using the network device, an assessment response from the LLM system corresponding to the assessment; and update the ML-assisted project initiation user interface with at least one unanswered question based on the assessment response.

The processor may be further configured to update the selected plurality of questions from the selected plurality of personas by filtering the questions based on a priority metric.

The processor may be further configured to: identify at least one sub-grouping of questions based on the assessment response, the at least one sub-grouping of questions at a different priority metric from the selected plurality of questions; and update the ML-assisted project initiation user interface with at least one sub-grouping of questions.

The memory may comprise a client database comprising at least one client fact, each client fact corresponding to a client identifier; and the processor may be further configured to: receive a client selection request comprising a selected client identifier; and wherein the assessment of the document content may comprise the at least one client fact in the client database corresponding to the selected client identifier.

The document content may comprise text.

The document content may comprise image data and the Large Language Model (LLM) system may comprise a multi-modal model.

The processor may be further configured to: identify at least two candidate Large Language Model (LLM) systems; and select the Large Language Model (LLM) system from the at least two candidate LLM systems.

The processor may be further configured to: receive, using the network device, a persona selection request comprising the selected plurality of personas; and wherein the assessment of the document content may comprise a selected plurality of questions from the selected plurality of personas.

It will be appreciated by a person skilled in the art that a system or method disclosed herein may embody any one or more of the features contained herein and that the features may be used in any particular combination or sub-combination.

These and other aspects and features of various embodiments will be described in greater detail below.

### DRAWINGS

For a better understanding of the described embodiments and to show more clearly how they may be carried into effect, reference will now be made, by way of example, to the accompanying drawings in which:

FIG. 1 shows a block diagram of an example ML-assisted project initiation system.

FIG. 2 shows a block diagram of an example computing device that may be used with the system of FIG. 1.

FIG. 3 shows an example user interface that may be displayed to a user of the system of FIG. 1.

FIG. 4 shows another example user interface that may be displayed to a user of the system of FIG. 1.

FIG. 5 shows another example user interface that may be displayed to a user of the system of FIG. 1.

FIG. 6 shows another example user interface that may be displayed to a user of the system of FIG. 1.

FIG. 7 shows another example user interface that may be displayed to a user of the system of FIG. 1.

FIG. 8 shows another example user interface that may be displayed to a user of the system of FIG. 1.

FIG. 9 shows another example user interface that may be displayed to a user of the system of FIG. 1.

FIG. 10 shows another example user interface that may be displayed to a user of the system of FIG. 1.

FIG. 11 and FIG. 12 show database diagrams in accordance with one or more embodiments.

FIG. 13 shows another example user interface that may be displayed to a user of the system of FIG. 1.

FIG. 14 shows another example user interface that may be displayed to a user of the system of FIG. 1.

FIG. 15 shows a flowchart of an example method of generating project initiation data.

FIG. 16 shows a flowchart of another example method of generating project initiation data.

The drawings included herewith are for illustrating various examples of systems, methods, and computer program products of the teaching of the present specification and are not intended to limit the scope of what is taught in any way.

### DESCRIPTION OF VARIOUS EMBODIMENTS

Various apparatuses or methods will be described below to provide an example of the claimed subject matter. No example described below limits any claimed subject matter and any claimed subject matter may cover methods or apparatuses that differ from those described below. The claimed subject matter is not limited to apparatuses or methods having all of the features of any one apparatus or methods described below or to features common to multiple or all of the apparatuses or methods described below. It is possible that an apparatus or methods described below is not an example that is recited in any claimed subject matter. Any subject matter disclosed in an apparatus or methods described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It should also be noted that the terms “coupled” or “coupling” as used herein can have several different meanings depending on the context in which these terms are used. For example, the terms “coupled”, or “coupling” can have a mechanical, electrical or communicative connotation. For example, as used herein, the terms “coupled”, or “coupling” can indicate that two elements or devices can be directly connected to one another or connected to one another through one or more intermediate elements or devices via an electrical element, electrical signal or a mechanical element depending on the particular context. Furthermore, the term “communicative coupling” indicates that an element or device can electrically, optically, or wirelessly send data to another element or device as well as receive data from another element or device.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

The example systems and methods described herein may be implemented in hardware or software, or a combination of both. In some cases, the examples described herein may be implemented, at least in part, by using one or more computer programs, executing on one or more programmable devices comprising at least one processing element, a data storage element (including volatile and non-volatile memory and/or storage elements), and at least one communication interface. These devices may also have at least one input device (e.g., a keyboard, a mouse, a touchscreen, and the like), and at least one output device (e.g., a display screen, a printer, a wireless radio, and the like) depending on the nature of the device. For example, and without limitation, the programmable devices (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some examples, the communication interface may be a network communication interface. In examples in which elements are combined, the communication interface may be a software communication interface, such as those for inter-process communication (IPC). In still other examples, there may be a combination of communication interfaces implemented as hardware, software, and a combination thereof.

Program code may be applied to input data to perform the functions described herein and to generate output information. The output information is applied to one or more output devices, in known fashion.

Each program may be implemented in a high-level procedural, declarative, functional or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Examples of the system may also be considered to be implemented as a non-transitory computer-readable storage medium, configured with a computer program, where the storage medium so configured causes a computer to operate in a specific and predefined manner to perform the functions described herein.

Furthermore, the example system, processes and methods are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Various examples of systems, methods and computer programs products are described herein. Modifications and variations may be made to these examples without departing from the scope of the invention, which is limited only by the appended claims. Also, in the various user interfaces illustrated in the figures, it will be understood that the illustrated user interface text and controls are provided as examples only and are not meant to be limiting. Other suitable user interface elements may be used with alternative implementations of the systems and methods described herein.

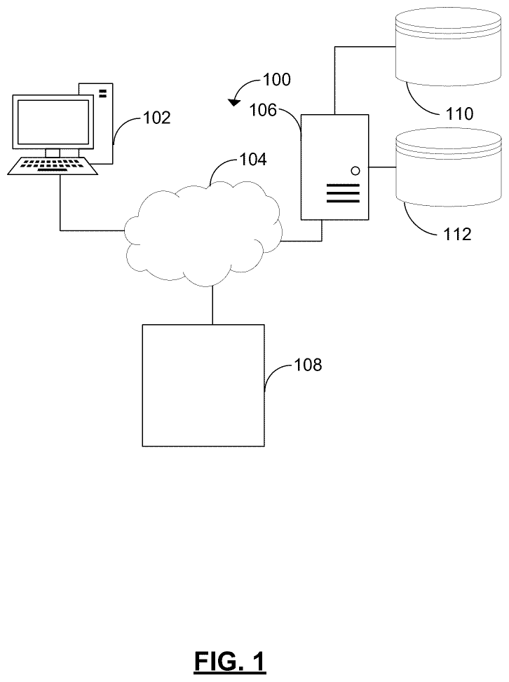

Referring first to FIG. 1, there is shown a block diagram an example ML-assisted project initiation system 100. The example system 100 can be configured to collect project initiation data for a project to be initiation. The example system 100 can be configured to generate, and prompt users to input, the project initiation data and to assess the collected project initiation data to ensure that all required data has been received. The example system 100 can incorporate user configured virtual personas in order to simulate the interaction of stakeholders with users in order to provide a streamlined data collection process.

A machine-learning assisted project initiation user interface can be provided to a user. The user interface can prompt a user to input project initiation data relating to a project to be initiated. The user interface can be integrated with an LLM that can be used to simulate interactions and to generate questions to prompt the user to submit project initiation data efficiently and optionally to create one or more project initiation documents.

The incorporation of user configurable persona data, as well as the use of the LLM system, can decrease the level of human involvement required at project initiation by decreasing human involvement in stakeholder feedback at early stages of project planning. This can streamline data collection and the generation of project initiation documents, and may be particularly beneficial in agency-based industries, such as consulting, marketing, legal, and other client-focused agency businesses.

In the illustrated example, the ML-assisted project initiation system 100 includes one or more user devices 102, a network 104, one or more servers 106, a persona database 110, a client database 112, and one or more LLM systems 108.

Each user device 102 may be used by a user such as an agency employee, designer, lawyer, consultant, associate or other user involved in creating a project initiation document.

Each user device 102 may be any two-way communication device with capabilities to communicate with other devices. The user device 102 can generally be in communication with (or able to establish communication with) server 106. The user device 102 may send and receive requests to the server 106 using different types of communication channels including text, email, phone call, Voice-over-Internet-Protocol (VOIP), web application, chat application, social media message, etc.

As will be understood, a user device 102 may be any suitable computing device capable of executing an application. User device 102 generally refers to a computing device such as desktop or laptop computers, smartphones, tablet computers, as well as a wide variety of “smart” devices capable of data communication. User devices 102 each include a processor, a volatile and non-volatile memory, at least one network interface, and input/output devices. User devices 102 may be portable, and may at times be connected to network 110 or a portion thereof. The user devices 102 may be a mobile devices such as mobile devices running the Google® Android® operating system or Apple® iOS® operating system.

Each of the user devices 102 can have a plurality of software applications operating thereon. The plurality of software applications can include a user project initiation application that can be used by the user of user device 102 in order to provide inputs to a process of generating project initiation data.

The user device 102 may be operated by a user to access a web-based user project initiation application (not shown) running on server 106 over network 104. Optionally, a user device 102 may access a web application hosted at server 106 using a browser application operating on the user device 102.

Alternatively or in addition, the user project initiation application may be a standalone program (or software application) that is downloaded and installed on the user device 102. A user device 102 may download an application (including downloading from an App Store such as the Apple® App Store or the Google® Play Store) for interacting with the server 106 and/or other user devices 102 as part of a process of generating project initiation data.

The user may access the user project initiation application, for example, to submit projection initiation data usable as document content for a project. The project initiation data can include text-based data and/or image data. Users can also submit additional project-related data, such as a project specification data or requirements data to the persona database 110 and/or client database 112.

The user may further use the user project initiation application to review the output in a project initiation user interface. The project initiation user interface can display output data relating to the project initiation process, including questions that may be identified as relevant to the document content. The user may further select and initiate a request for project initiation document creation based on the collected project initiation data.

The request for project initiation document creation can initiate the generation of a variety of different types of project initiation documents, including a formal project initiation document such as a Request For Proposal document, a Request For Quote, or other project initiation documents using the project initiation data (e.g. document content) received from the user interface.

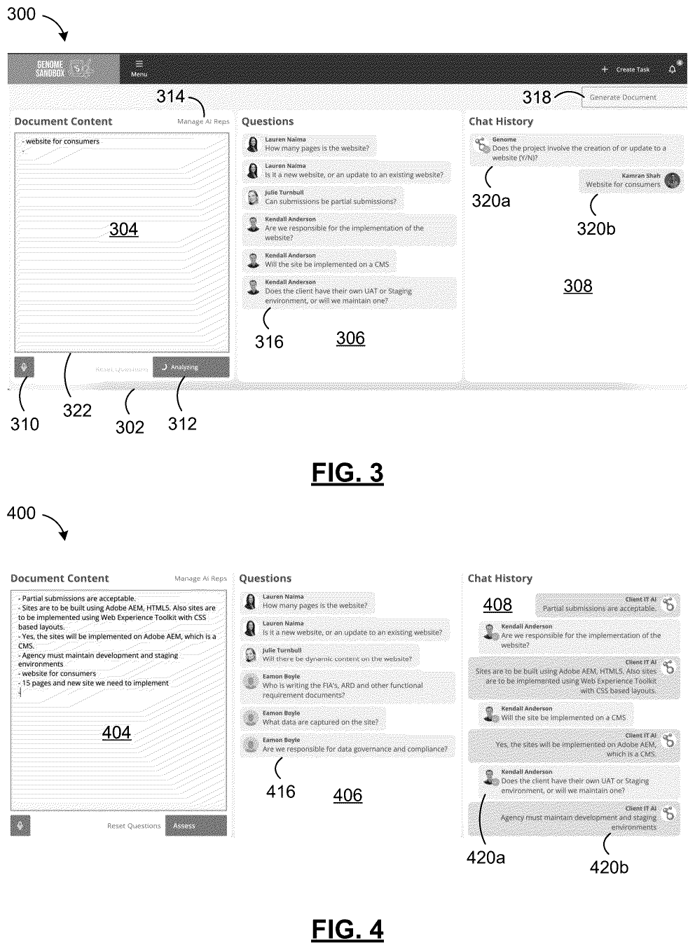

The user project initiation application may include a chatbot interface. The user project initiation application may enable users to upload documents and data pertinent to the project initiation process. Example user interfaces that may be displayed by the user project initiation application are shown in FIGS. 3-10 and 13-14 described herein below.

The user project initiation application may communicate with server 106 using an Application Programming Interface (API) endpoint, and transmit data and requests relating to the project initiation process to the server 106 through the API endpoint.

Network 104 may be any network or network components capable of carrying data including the Internet, Ethernet, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

Server 106 is a computer server that is connected to network 104. Server 106 has a processor, volatile and non-volatile memory, at least one network interface, and may have various other input/output devices. As with all devices shown in the system 100, there may be multiple servers 106, although not all are shown.

The server 106 is in network communication with the one or more user devices 102. The server 106 may further be in communication with several databases such as persona database 110, and a client database 112. The databases 110 and 112 and the server 106 may be provided on the same server device, may be configured as virtual machines, or may be configured as containers. The server 106 and databases 110, 112, 114 and 116 may run on a cloud provider such as Amazon® Web Services (AWS®).

The server 106 may host a web application or an Application Programming Interface (API) endpoint that the one or more user devices 102 may interact with via network 104. The server 106 may make calls to the database at databases 110 and 112 to query persona data, client data, configuration data, or other data received from the users of the one or more user devices 102. The requests made to the API endpoint of server 106 may be made in a variety of different formats, such as JavaScript Object Notation (JSON) or extensible Markup Language (XML).

The databases 110 and 112 may store persona data, client data, and configuration information. The client database 112 may further be used to store project initiation documents when created, as well as the document content and any other project initiation data submitted by users (and optionally simulated users) as they receive feedback from AI-assisted representatives. The databases 110 and 112 may be a Structured Query Language (SQL) such as PostgreSQL or MySQL or a not only SQL (NoSQL) database such as MongoDB. The databases 110 and 112 may further include vector databases such as Pinecone.

One or more LLM systems 108 are in network communication with the server 106. The LLM systems may be accessed by the server 106 using an API of the LLM system. The system may use an LLM (GPT-4 or similar) to analyze the project initiation document content and/or other project initiation data. The analysis of the project initiation document content and/or project initiation data can be based on client facts and persona descriptions in order to identify feedback. Detailed prompts and predefined crafted prompts may enable the LLM to adapt to the different types of questions such as image recognition features of the LLM.

Optionally, the LLM systems may also be used to identify project initiation data relevant to one or more selected questions. For example, the LLM systems can be used to assess stored client data or project data to identify pre-stored data responsive to selected project initiation questions. Alternatively or in addition, the LLM systems can be used to infer that the user-submitting project initiation data is responsive to one or more selected project initiation questions.

The one or more generative AI systems 108 may include various types, models and versions of generative AI systems, including but not limited to one or more of the following example systems:
GPT-2 made by OpenAIR
GPT-3 made by OpenAIR
GPT-Neo made by EleutherAI®
GPT-J made by EleutherAI®
Ernie 3.0 Titan made by Baidu®
Claude made by Anthropic®
LaMDA (Language Models for Dialog Applications) made by Google®
GPT-NeoX made by EleutherAI®
PaLM (Pathways Language Model) made by Google®
LLAMA (Large Language Model Meta AI) made by Meta®
GPT-4 made by OpenAI®
PaLM 2 (Pathways Language Model 2) Google®
Llama 2 made by Meta®

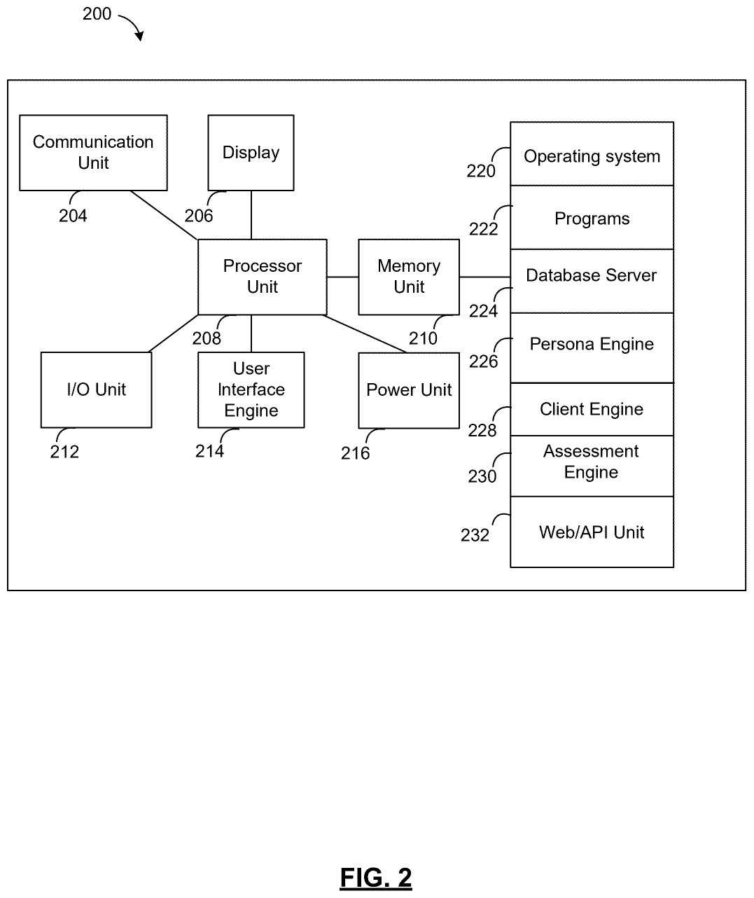

Referring next to FIG. 2, there is shown a block diagram of an example server device 200 that may be used as server 106 in the example system 100 of FIG. 1.

The communication unit 204 can include wired or wireless connection capabilities. The communication unit 204 can include a radio that communicates using standards such as IEEE 802.11a, 802.11b, 802.11g, or 802.11n. The communication unit 204 can be used by the server 200 to communicate with other devices or computers, such as a user device 102 and/or generative model 108. Communication unit 204 may communicate with a network, such as network 104 (see FIG. 1).

The display 206 may be an LED or LCD based display and may be a touch sensitive user input device that supports gestures. Optionally, display 206 may be omitted, for instance where the server 200 is a virtual server or is accessed through a separate device such as a user device 102.

The processor unit 208 controls the operation of the server 200. The processor unit 208 can be any suitable processor(s), controller(s) or digital signal processor(s) that can provide sufficient processing power depending on the configuration, purposes and requirements of the server 200 as is known by those skilled in the art. For example, the processor unit 208 may be a high-performance general processor. Alternatively or in addition, the processor unit 208 can include more than one processor with each processor being configured to perform different dedicated tasks. Alternatively or in addition, the processor unit 208 may include a standard processor, such as an Intel® processor or an AMD® processor.

The processor unit 208 can also execute a user interface (UI) engine 214 that is used to generate various UIs for delivery via a web application provided by the Web/API Unit 230, some examples of which are shown and described herein, such as interfaces shown in FIGS. 3-10 and 13-14.

The memory unit 210 can include RAM, ROM, one or more hard drives, one or more flash drives or some other suitable data storage elements such as disk drives, etc. The memory unit 210 is used to store an operating system 220 and programs 222 as is commonly known by those skilled in the art.

The memory unit 210 further stores software code for implementing an operating system 220, programs 222, database server 224, persona engine 226, client engine 228, assessment engine 230, and web/API unit 232.

The I/O unit 212 can include at least one of a mouse, a keyboard, a touch screen, a thumbwheel, a trackpad, a trackball, a card-reader, an audio source, a microphone, voice recognition software and the like again depending on the particular implementation of the server 200. Optionally, some of these components can be integrated with one another. Optionally, the I/O unit 212 may be omitted from server 106.

The user interface engine 214 can be configured to generate interfaces for users to enable a user to interact with a user project initiation application. For example, user interfaces may be provided to enable users to configure the ML-assisted project initiation system, send document content and other project initiation data, receive and view AI-generated representative feedback including selected questions, send project initiation document requests, receive ML-assisted project initiation documents, etc. The various interfaces (or interface data) generated by the user interface engine 214 may be transmitted to a user device by virtue of the Web/API Unit 232 and the communication unit 204. The interface data transmitted to the user device can be used by the user device to render the user interface of the user project initiation application on the user device.

The power unit 216 can be any suitable power source that provides power to the server 200 such as a power adaptor or a rechargeable battery pack depending on the implementation of the server 200 as is known by those skilled in the art.

The operating system 220 may provide various basic operational processes for the server 200. For example, the operating system 220 may be a server operating system such as Ubuntu® Linux, Microsoft® Windows Server® operating system, or another operating system.

The programs 222 include various user programs. They may include several hosted applications delivering services to users over the network, for example, an agency relations management (CRM) system.

Optionally, the programs 222 may provide a marketing or document creation platform that is web-based, or client-server-based application via Web/API Unit 232 that provides for the creation of project documents.

The database server 224 may be a database application providing the persona database 110, the client database 112 (see e.g., FIG. 1) for storing data associated with a project initiation process and project initiation documents and/or data. The client database 112 may further be used to store the project initiation documents and/or data when created, as well as document content and other project initiation data submitted by users during a process of generating project initiation data, for instance as users receive feedback from AI-assisted representatives. While the database server 224 is shown as operating on a single server 200 with the ML-assisted project initiation system, it is understood that the database may be located separately on another server or system in network communication with the server 200. The database server 224 may store the persona database and client database as flat files using naming conventions that aid in quick access and retrieval.

The persona database stored on database server 224 may include persona data corresponding to a plurality of personas. The persona data for a particular persona can include persona characteristic data such as a persona identifier, a persona name, and a persona expertise type for example. The persona data for a particular persona can also include associated question data indicating at least one question associated with the persona instance.

The persona data can also include question data relating to a plurality of questions to be used in a process of generating project initiation data. The question data for a given question can include a question identifier and question content data that defines the content of the question to be presented to a user during the process of generating project initiating data.

The question data for a given question may include question applicability data. The question applicability data can provide an indication of the type of projects and/or clients for which the question is relevant and should be included in the process of generating project initiation data (i.e. is relevant for inclusion as a question prompt in the user interface displayed to the user_. For example, the question applicability data can specify whether a question applies across a project, a project type, a portfolio, or other scopes of work.

The question data for a given question may also include question priority data. The question priority data can define or specify the importance of the question to a process of generating project initiation data. Optionally, the question priority data for a given question may further vary depending on the type of project for which the question may be used. That is, a given question may have a plurality of type specific question priorities for different types of project initiation processes.

Optionally, the plurality of questions may be stored in a hierarchical format. For example, the plurality of questions may include branching sets of questions that can include branches for sub-questions or questions that provide clarification or expansion on earlier questions. The top level questions may serve or operate as gating questions that determine whether the remaining sub-questions within that branch are relevant to the project being initiated.

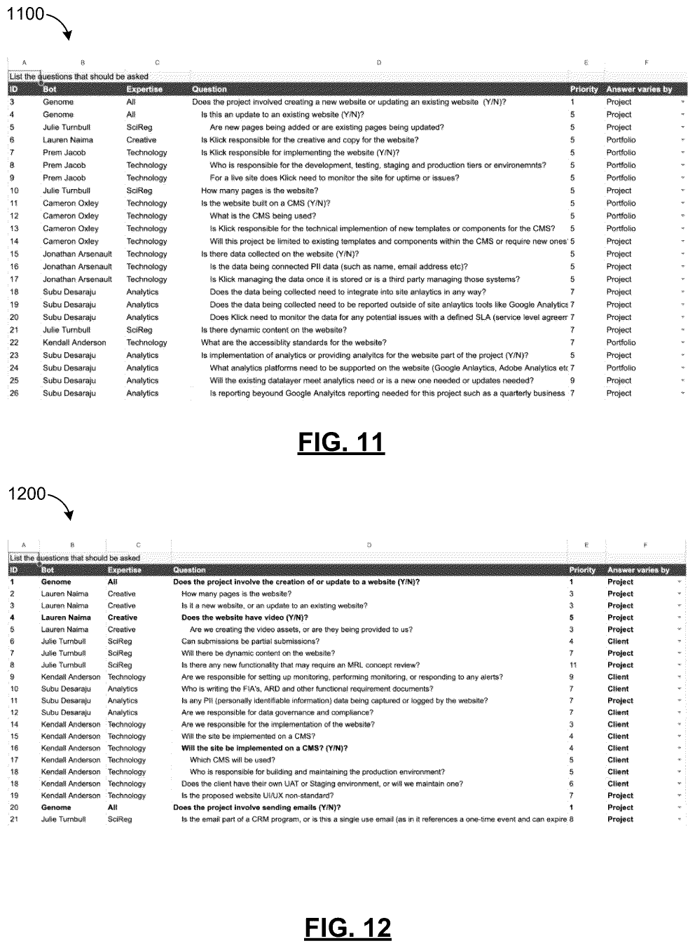

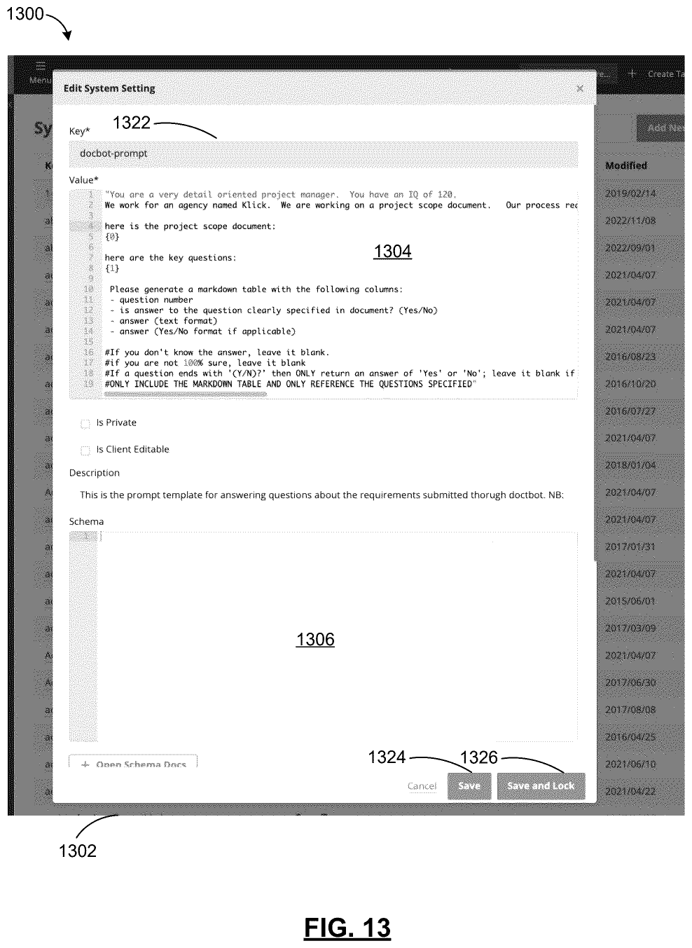

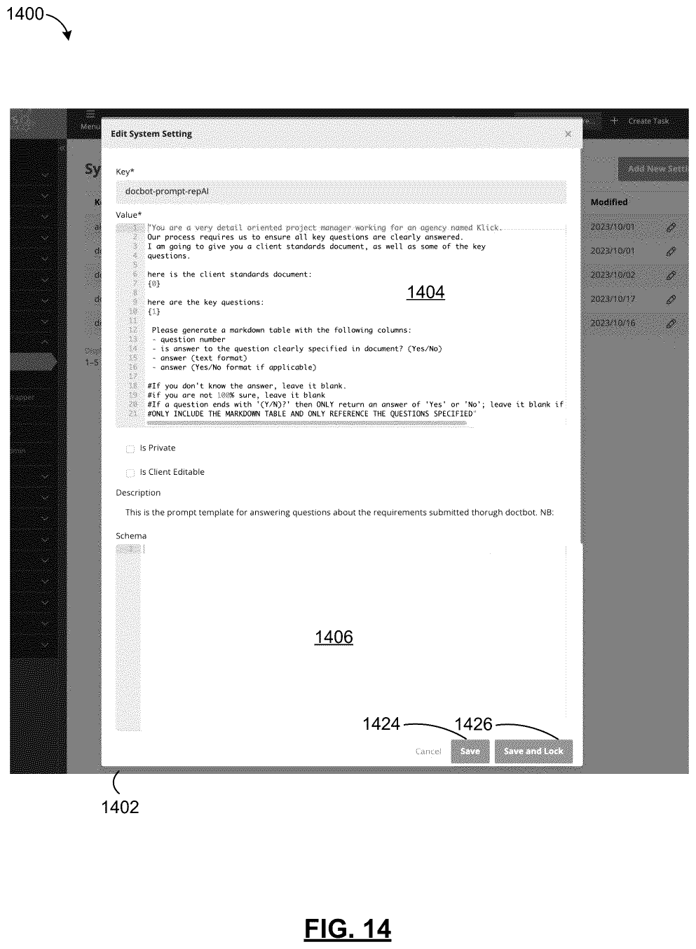

The persona database may include persona data for variety of different professionals, including marketing professionals, professionals, legal professionals, regulatory professionals, analytics professionals, creative professionals, or other individuals who may typically be involved in a process of generating project initiation data. There may be a large number of personas in the database, including more than 100, or more than 1,000 distinct persona instances. Simplified examples of the persona data that may be stored by a persona database are shown, for example, in FIGS. 11 and 12 described herein below.

The persona data stored in the persona database can include real-world persona data based, at least in part, on real people. This may enhance the user experience and engagement when participating in a process of generating project initiation data as the user may be more receptive to questions from representations of personas corresponding to real individuals they know of, or are aware of. Alternatively or in addition, the persona data can include artificial persona data based on simulated or user-constructed individuals who do not exist in real life. The personas may represent people (virtual or real) at the agency or consultancy itself, or also may represent people (virtual or real) at a particular client.

The persona data can be used to create persona representatives or instances of particular personas. The persona representatives can be used within an individual process of generating project initiation data.

Optionally, the persona data stored in the persona database may include one or more persona avatars. A persona avatar may be stored in association with a particular persona or a persona type (e.g. a type of stakeholder), including real or virtual personas. The avatars may include image representing a person associated with the persona or persona type.

The persona data can be defined based on one or more default settings. Optionally, the persona database may be updated dynamically by the persona engine to dynamically update and change the persona data such as images, names and questions associated with the personas stored in the persona database.

The client database stored on database server 224 can be used to store client data corresponding to a plurality of clients. The client data can include contextual client data about each client.

The contextual client data can include, for example, prior client work data (e.g. a vector-database representation of prior work product created for the client), prior client work product data (e.g. a vector-database representation of client materials or documents such as for example, standardization documents, standard operating procedures of the client, regulatory requirements of the client, etc.). The contextual client data can be stored, for example using a document management system (e.g. iManage) or source-code management system (e.g. Git or Subversion).

Optionally, the client database can store individual client portfolios for each client that include groupings of work (such as, for example, corresponding to a particular client product or service). The client portfolio level may be independently queryable in the client database.

The client data can provide multiple sources of input that can be used to prepare prompts for the LLM system in order to generate feedback based on the project initiation data being generated. The client data can also be used to generate project initiation data. For example, the LLM system may parse the stored client data to determine whether any project initiation data is already available in the stored client data. The identified project initiation data may then be collected, for instance using a virtual user in the user interface of the project initiation application.

The client data can include client-specific configuration data (which can be defined to be true at a client level—i.e. for all projects for a particular client, but may not be true for other clients), portfolio-specific configuration data (which can be defined to be true at a portfolio level—i.e. for all projects within a particular portfolio, but may not be true for other projects within other portfolios including other portfolios for the same client), and project-specific configuration data (which can be defined to be true at a project level—i.e. for a particular project, but may not be true for other projects including other projects for the same client and/or within the same portfolio).

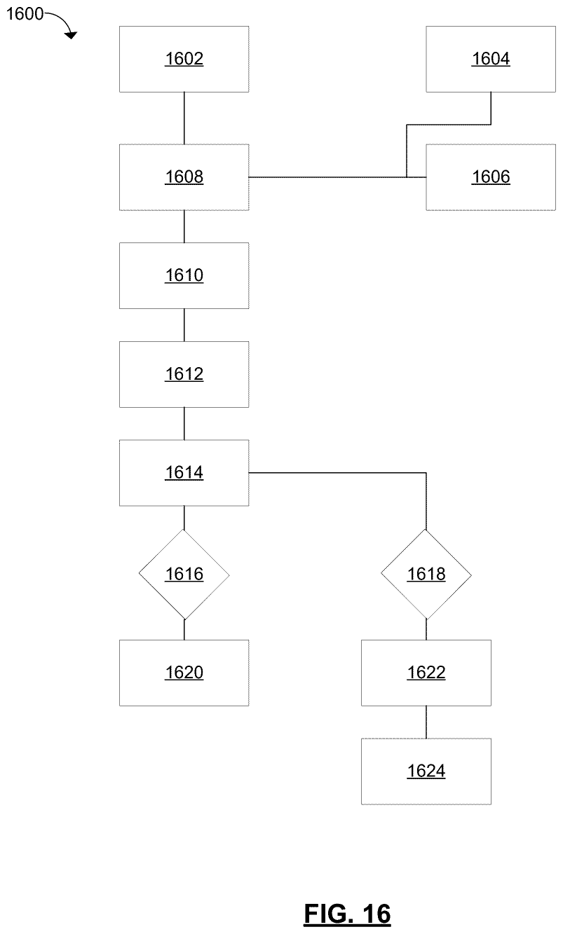

The persona engine 226 can provide various functions relating to a process of generating project initiation data, such as for example portions of the methods shown in FIGS. 15 and 16.

For example, the persona engine 226 can be configured to generate or define virtual representatives that can provide feedback on project initiation data (e.g. document content) supplied by a user during a process of generating project initiation data. Each virtual representative can be based on a persona stored in the persona database. The persona engine 226 can generate a plurality of virtual representatives based on the plurality of stored persona instances.

The plurality of virtual representatives can be selected by the persona engine 226 to ensure that a wide range of questions are selected and included for feedback to the user. The plurality of virtual representatives can be selected by the persona engine 226 to ensure that the set of questions presented to users are spread across different types of personas and/or expertise groupings within a particular organization involved in the process of generating project initiation data.

Individual personas may be identified by a name (see e.g. Column B in FIGS. 11 and 12). As noted above, individual personas can also be defined with particular types of expertise (see e.g. Column C in FIGS. 11 and 12). As further noted above, each persona may have associated questions such as the example questions shown in Column D in FIGS. 11 and 12.

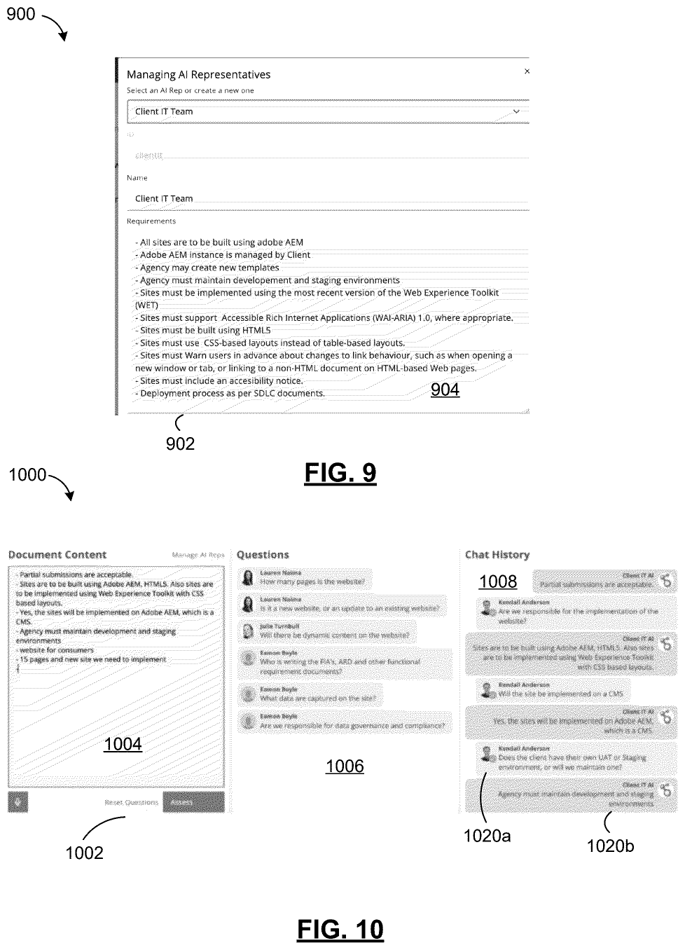

Optionally, a user may specify or define user-configured personas. For example, a user of the ML-assisted project initiation system may configure personas using a persona configuration user interface such as the example persona configuration user interfaces shown in FIGS. 8 and 9. The user-configured personas may be used to create virtual representatives for feedback. A user may define user-configured personas to represent team members or other organization members known to the users involved in the process of generating project initiation data.

The assessment engine 230 may provide various functions relating to a process of generating project initiation data, such as for example the methods shown in FIGS. 15 and 16. For example, the assessment engine can be configured to select questions associated with the persona of several AI representatives. Optionally, the assessment engine 230 may select an initial set of questions to be displayed in an initial round of questioning during a process of generating project initiation data. The initial set of questions may be defined, at least in part, based on question priority data (e.g. as shown in a question priority field such as column E in FIGS. 11 and 12) associated with the stored questions.

The questions associated with particular personas, (e.g. as shown as rows in FIGS. 11 and 12) may reflect specific concerns or facets of the corresponding persona. The questions associated with individual personas can be used by a virtual representative (corresponding to the persona) during an assessment of project initiation data (e.g. document content) by the ML-assisted project initiation user interface. The questions can be defined to elicit an expected sufficient amount of project initiation data for a draft of a project initiation document to be generated.

As noted above, questions may be stored and represented in a hierarchical format, including branches for sub-questions. The initial set of questions can be selected to prompt a user to provide initial project initiation data. The initial project initiation data may be insufficient to complete a draft of the project initiation document(s) absent additional question prompts. However, the initial set of questions may be defined to be intentional underinclusive to avoid overwhelming a user inputting data to the user interface. This may ensure that the user provides complete initiation data relating to different aspects of the project, prior to including additional or subsequent question prompts to elicit further project initiation data that is more specific or related to other aspects of the project. The additional or subsequent question prompts may be determined, at least in part, based on the project initiation data collected.

The set of initial questions may be selected by the assessment engine 230, for example, by distributing persona-associated questions across all of the representatives involved in reviewing the project initiation data (e.g. document content). For example, a user may identify and select a group of representatives to provide feedback on the project initiation data (e.g. document content) based on the persona data indicating available persona representatives. The set of initial questions can then be assigned or distributed to the selected representatives to populate the questioning interface for a process of generating project initiation data.

The set of initial questions can be selected by the assessment engine 230 based on the question priority data. For example, higher priority questions (e.g. questions of a priority level 1) may be selected by the assessment engine first, ahead of the questions from lower priority levels. The higher priority questions may include more general questions, while lower priority levels may include more detailed or specific questions. In some cases, the lower priority level questions may be defined to elicit more granular project initiation data than the higher priority level questions.

The assessment engine may also select additional or subsequent questions based on responses to questions in the initial set of questions. For example, a particular response (e.g. an answer in the affirmative) to a particular question may trigger the assessment engine to select a sub-branch related to that question and select further, lower priority questions to be included in the questioning interface in order to elicit the necessary requirements for the document.

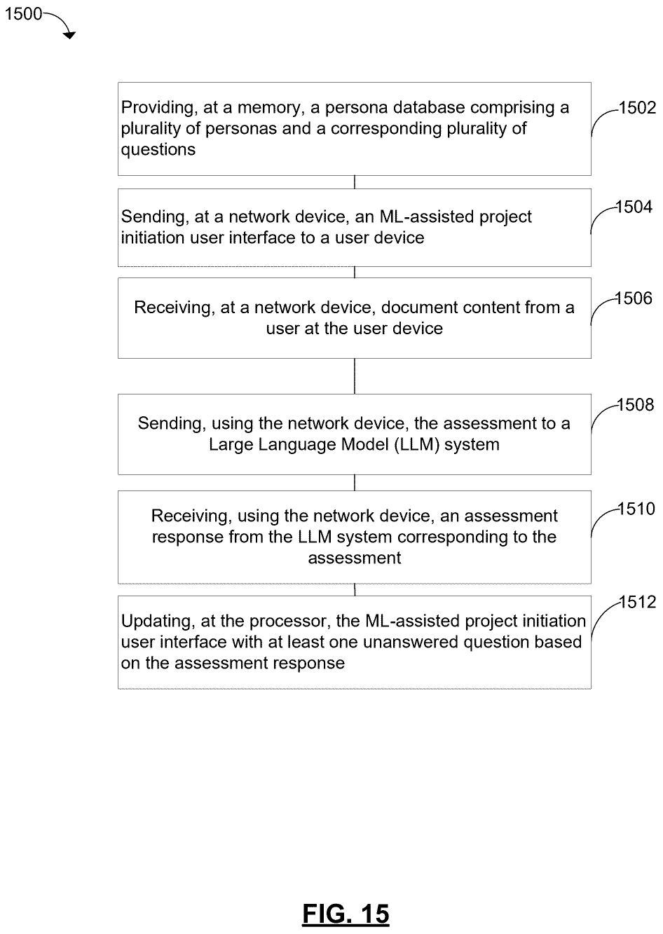

The assessment engine 228 can provide integration with the LLM system. This may include a variety of LLMs such as those described for LLM system 108 (see FIG. 1). The assessment engine 228 may, for example, integrate with the LLM system to determine whether the project initiation data provided by users includes responses to the set of initial questions (or subsequent questions) or a subset thereof. For example, the assessment engine may transmit a question assessment prompt to the LLM system that includes the provided project initiation data and one or more selected questions to assess whether the provided project initiation data is responsive to the one or more selected questions. For example, the assessment engine may use the prompt 1404 (see FIG. 14) to prompt the LLM system to assess the project initiation data (e.g. document content) using the selected questions.

Optionally, questions to be assessed may be selected and sent to the LLM system in a batch. For example, the questions to be assessed may be batched 5 at a time, and the LLM system can be prompted to provide an analysis of the batched questions in a single question assessment response. If the assessment engine 230 determines from the LLM response that an answer has been provided to a question, the assessment engine 230 can store the answer. The assessment engine 230 can also provide a question answered indication in the user interface that the question has been answered. If the assessment engine 230 determines from the LLM response that a question has not been answered, the assessment engine 230 may take further project initiation data collection steps. For example, the assessment engine 230 may search using the vector database associated with the client database or the persona database to determine whether there is responsive data elsewhere in other documents.

Optionally, the system can assess previously stored client data (e.g. by querying the client database) to determine whether project initiation data is available from the client data. The LLM system may assess the previously stored client data in combination with the selected questions to determine whether any project initiation data can be collected automatically. Where project initiation data is identified in previously stored data (e.g. from the client database), the user interface may include a virtual user to input the identified project initiation data into the user interface. This may provide a collaborative user experience when engaging with the project initiation user application.

The assessment engine 228 may include data when sending question assessment prompts to the LLM system, including the selected questions (and potentially, sub-questions), query results from the client database (i.e. where the client database contains a vector database there may be contents provided to the LLM system in order to provide answers to the questions).

The assessment engine 228 may receive a question assessment response from the LLM system based on the prompt request. The question assessment response from the LLM system may be stored in the client database, e.g. in association with the particular project.

The Web/API Unit 232 may be a web-based application or Application Programming Interface (API) such as a REST (REpresentational State Transfer) API. The API may communicate in a format such as XML, JSON, or other interchange format.

The Web/API Unit 432 may provide various functions relating to a process of generating project initiation data. For example, the Web/API Unit 432 may receive a project initiation data generation request including a project initiation document content and selected questions and/or AI representative information based on persona information. The Web/API Unit 432 may apply methods such as those described herein to determine if sufficient information has been provided to answer the questions associated with each of the AI representatives (e.g. using the assessment engine).

Referring next to FIG. 3, there is shown an example user interface 300 that may be provided as part of a ML-assisted project initiation user interface. The example ML-assisted project initiation user interface 302 illustrated includes a collected project initiation data section (e.g. document content section 304), a question section 306, and a chat history section 308. The user interface 302 can further include a document generation input 318. The input 318 can be selected by a user to initiate the automatic generation of project initiation documents based on the collected project initiation data. The user interface 300 can provide a user with access to AI-based application for collecting project initiation data. The AI-based application for collecting project initiation data can enable the intake/collection of data responsive to a partial or full set of requirements for a particular project using an iterative posed question and classification approach as described herein. This can ensure necessary requirements are defined at the outset of a project in order to assist in a successful project and program delivery.

As illustrated, the collected project initiation data section 304 can include a user-editable document content field 322 a ML-representative selection input 314, an assessment input 312, and a voice entry input 310. A user can manually enter project initiation data (e.g. document content) for a project initiation document in the project initiation data field 322. This can include requirements, configuration, features, or other content that identifies the nature of the project. The project initiation data may be provided by a user through various input devices, such as text input device (e.g. a keyboard or touchscreen) or audio input devices such as a microphone. Optionally, a user may select voice entry button 310 and use text-to-speech on the user device to provide the project initiation data. The project initiation data 322 may include text as shown, or may alternatively include image data such as wireframes, flowcharts, or other technical images.

Optionally, the user may select a plurality of virtual representatives using the user interface control 314. The virtual representatives may be created based on one or more personas as described herein.

A user may submit the project initiation data 322 for assessment by the selected representatives using the assessment button 312. The assessment button 312 may send a request to the project initiation document generation system, which may in turn execute the method of FIGS. 15 and 16 in order to identify questions based on the project initiation data collected thus far.

The submitted project initiation data 322 may be input using different mechanisms, including the use entering information using an input device such as a keyboard, the use of the clipboard to copy and paste content, document upload (for example, a text file, Microsoft® Word® document, Microsoft® Excel® spreadsheet, etc.), a cloud-based stored file, voice entry, video entry with voice transcription processing.

Furthermore, automated data processing may be used to provide additional information not manually provided by the user including transcription of meeting notes from a video or online meeting, Slack® or other messaging communication.

The submission of the assessment (e.g. using assessment button 312) may allow for additional exploration questions to be identified and presented/posed to the user. The exploration questions can prompt a user to provide project initiation data required to accurately define the project and associated project requirements. and the selection of exploration questions may streamline the project initiation process, for instance by only presenting a user with questions necessary to elicit additional project initiation data. This may include a logical hierarchy of information gathering (similar to a tree structure) using the hierarchical set of questions where nodes are only explored if necessary. For example questions relating to emails may be omitted if email communication is out of scope of the project. Similarly, if dynamic content modules are out of scope while emails are in scope then email-related questions can be included while omitting questions relating to the management of dynamic content.

The question column 306 and the chat history column 308 may be updated in response to initiating an assessment of the collected project initiation data. The assessment response can include additional questions being identified based on project initiation data 322 provided by the user. The user interface can be updated in real-time to enable a user to rapidly identify the data collected thus far and any remaining project initiation data required.

The additional questions added to question column 306 may be identified based on context of the project initiation data 304 provided, including previously provided project initiation data. For example, the project initiation data indicates a “website” not a “datawarehouse” so the additional questions identified in question column 306 relate to data required for projects relating to websites. The questions selected can be determined based on different stakeholders needs (creative, technology, user experience, analytics etc).

As the collected project initiation data includes responses to the selected questions, the user interface can provide the user with feedback indicating that the required project initiation data has been input. For instance, when a selected question is answered the middle column may provide visual feedback by turning green, and the selected question and project initiation data providing the answer can be included in the chat history column 308. The selected question (once answered) may also be removed from the set of question prompts displayed in the user interface (e.g. in section 406) while unanswered questions remain.

The question section 306 can include one or more selected questions associated with selected virtual representatives (e.g. representatives selected using representative selection 314). Additional examples of questions are shown in FIGS. 11 and 12 for example.

The set of question prompts displayed in the in section 406 can include questions identified in the assessment results as being necessary and unanswered from the as-yet collected project initiation data 322. Responsive to the set of question prompts 306, a user may add or update the project initiation data 322, by, for example, adding new content, changing the existing document content, or removing document content.

Each question prompt in the question section 306 may include a virtual representative (e.g. an avatar and a representative name), and unanswered question text. For example, question 316 is associated with a virtual representative named Kendall Anderson, and includes their avatar, along with the unanswered question.

The chat history section 308 can be updated as project initiation data is collected and assessed. The chat history section 308 can be updated in real-time, e.g. as a user provides input to the content section 304 and/or an assessment occurs. The chat history section 308 can indicate each identified question 320a and the corresponding project initiation data 320b provided by the user that is responsive to the question.

The user interface 302 can also be used to generate outputs for further use in the process of collecting project initiation data and/or generating a project initiation document. For example, a user can interact with the user interface 302 to perform functions such as exporting the chat history, exporting the set of selected questions in the question section 306, updating the project initiation data 404 by inserting addition project initiation data into appropriate portions of the section. For example, a user may provide additional project initiation data that includes clarifications on dynamic content into a dynamic content portion, suggestive project initiation data that may be entered as suggestions or comments. A user may also interact with the interface to perform additional functions such as exporting a comprehensive project initiation document, and/or exporting a project plan with deliverables based on the collected project initiation data provided through the user interface.

Referring next to FIG. 4, shown therein is another example user interface 400 that may be provided as part of a ML-assisted project initiation user interface. The example user interface 400 is generally similar to the user interface 300 (see FIG. 3), with additional project initiation data having been collected.

As can be seen in the example of FIG. 4, the questions section 406 contains new unanswered questions such as Eamon Boyle's representative question “Are we responsible for data governance and compliance” 416. The chat history section 408 contains question data relating to previously answered questions and the corresponding responsive project initiation data, and the question section 406 can include additional and unanswered questions.

A user may edit the content in the project initiation data section 404 on an ongoing and/or iterative basis in response to the outstanding question prompts 406.

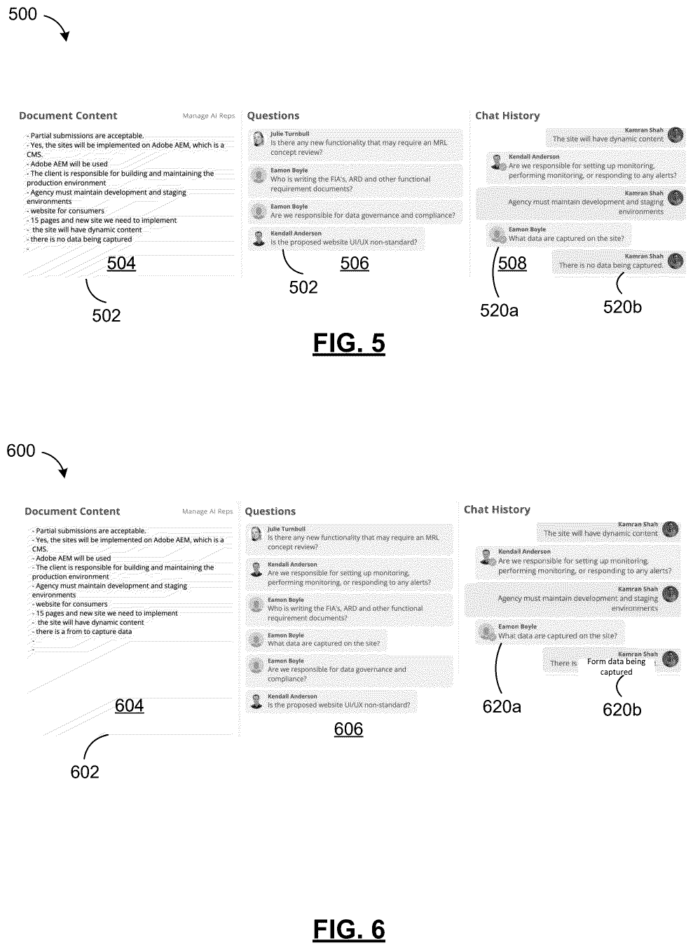

Referring next to FIG. 5, shown therein is another example user interface 500 that may be provided as part of a ML-assisted project initiation user interface.

As noted above, the questions included in the question section 506 are selected for display to the user as needed (e.g. based on previously collected project initiation data and/or an assessment response). For example if the project initiation data input by a user indicates that data is not collected on a website, the assessment response may omit questions about what type of data is being collected.

Referring next to FIG. 6, there is shown another example user interface 600 that may be provided as part of a ML-assisted project initiation user interface. In FIG. 5, the project initiation data 504 indicated that user data is not being collected. However here in FIG. 6, the project initiation data 604 supplied by the user has changed to indicate that data is being collected. Accordingly, the assessment response may indicate that additional questions related to data collection should be included in the selected set of questions.

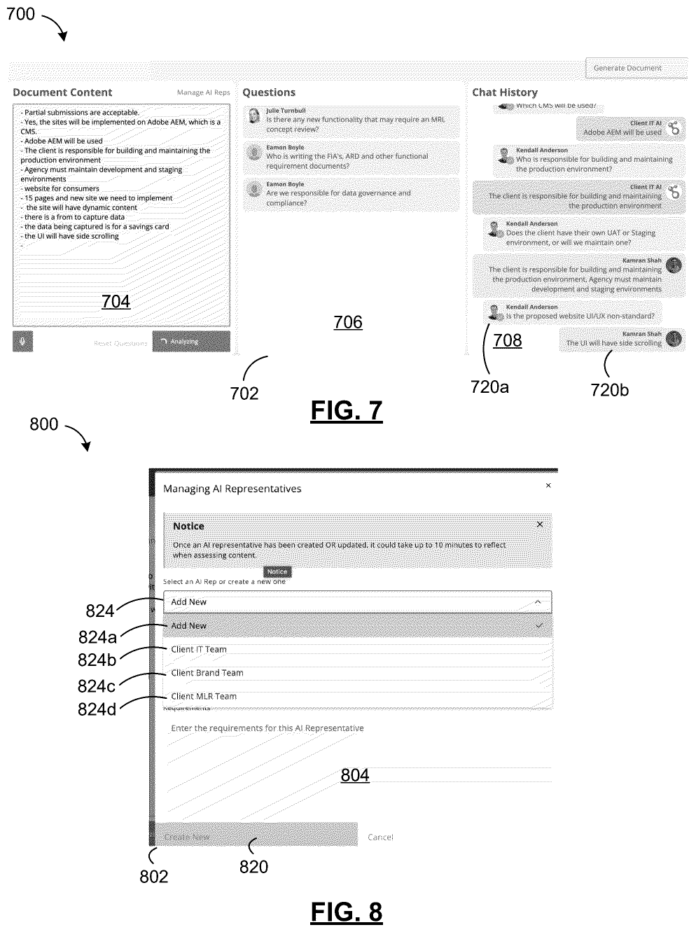

Referring next to FIG. 7, there is shown another example user interface diagram 700 that may be provided as part of a ML-assisted project initiation user interface.

As shown in the example of user interface 702, project initiation data 704 provided by the user has been identified in the assessment response from the LLM system as responsive to a question posed through inference. Here, the project initiation data includes “the UI will have side scrolling” which has been identified as an answer 720b (i.e. responsive project initiation data) to the question “is the proposed website UI/UX non-standard” 720a even though it is indirectly answered.

Referring next to FIG. 8, there is shown another example user interface 800 that may be provided to a user to manage virtual representatives as part of a ML-assisted project initiation user interface. A user may select the “Manage AI Representatives” button 314 (see e.g. FIG. 3) which may trigger the display of the user interface 802. The AI Representatives may operate as virtual users who can assist in the generation and collection of project initiation data.

The user interface 802 may enable the user to select representatives directly and/or input baseline requirements for virtual users. These virtual users may enable extending the core data model of questions and information asked of the user and also provide upfront answers to questions.

The user interface 802 for managing virtual users may include a selection box 824 that includes at least two selectable virtual users that may be selected by the user to provide feedback on the collected project initiation data. Here, examples of representatives includes an Add New button 824a provided to allow a user to create a new representative, along with previously created virtual users client IT team 824b, client brand team 824c, and client MLR team 824d.

The user interface 802 may further include a requirement box 804 where a user may identify text-based requirements for the virtual user. The user interface 802 may further include a create button 820 for a user to create (or, if an existing representative is selected, update) the virtual user.

Referring next to FIG. 9, there is shown another example user interface 900 displaying characteristics of a pre-populated virtual user (e.g. responsive to the selection of an existing representative in FIG. 8). A virtual user may correspond to a persona instance as described herein.

The interface 902 identifies the configuration including requirements for the virtual user “Client IT Team”. The requirements 904 for the virtual user may include particular needs of the virtual user and thus associated particular questions about the project initiation data. The requirements 904 may further include project-related facts that define how the virtual user may engage with the project initiation data during the process of generating project initiation data.

For example, the project-related facts may include client-specific requirements. As shown in the example of user interface 900, the requirements 904 include “All sites are to be built using adobe AEM. Adobe AEM instance is managed by Client. Agency may create new templates. Agency must maintain development and staging environments. Sites must be implemented using the most recent version of the Web Experience Toolkit (WET). Sites must support Accessible Rich Internet Applications (WAI-ARIA) 1.0, where appropriate. Sites must be built using HTML5. Sites must warn users in advance about changes to link behavior, such as when opening a new window or tab, or linking to a non-HTML document on HTML-based web pages. Sites must include an accessibility notice. Deployment process as per SDLC documents.” These pre-defined client related facts can be evaluated when assessing whether project initiation data is previously stored.

Referring next to FIG. 10, there is shown another example user interface 1000. In user interface 1000, the client IT team defined in interface 900 has been selected to be a virtual user as part of a ML-assisted project initiation user interface.

The addition of the pre-populated virtual user for “Client IT Team” from FIG. 9 using requirements 904 can also update other sections of the user interface. As shown, the project initiation data 1004 and chat history 1008 sections have been automatically updated based on the requirements of the “Client IT Team” requirements 904. For example, user interface 1000 includes question prompts to provide answers based on the requirements 904 such as “Does the client have their own UAT and staging environment, or will we maintain one?” question 1020a which is answered 1020b by the client IT team virtual user from FIG. 9 based on the client-specific facts associated with the project.

Alternatively, a virtual user may be defined by default to enable the system to include previously stored client data in the user interface. This may allow the user to avoid the need to define requirements for a virtual user.

Referring collectively to FIG. 11 and FIG. 12, example database diagrams 1100 and 1200 are shown. The database drawings show an example of the persona database. The persona database may include a question table storing the questions associated with each persona in different fields.

The example data fields associated with each question may include:
column A identifying a question identifier.
column B identifying the “Name of the representative” or bot.
column C identifies the “Expertise” associated with the question. This may include different fields of expertise that a question may be associated with. The expertise may be used by the present systems and methods in order to select which question are posed and when. The expertise may also reflect the type of persona to be associated with this question. The present systems and methods may select from different expertise areas to ensure multiple expertise areas are used to assess document content.
column D provides a question content, which may include “Y/N” questions. Where the answer is deemed to be No then the child questions may be skipped. Subsequent document content may result in a N to a Y answer and may trigger the questions in that branch being asked.
column E is a priority identifier that may signify a relative order in which the questions should be selected by the assessment engine.
column F may provide a scope of the question. If the question should be asked for each project, the Project scope may be selected. This change may result in the question being asked for every project. If the question should be answered for a collection of projects (Brand, Department) then Portfolio may be selected. Answers provided for questions at the Portfolio level may be used to answer similar questions for other projects in the same portfolio. If the question applies at a client level (would be true for all brands, departments and projects) the scope may be set to “Client”. If answered in any project for that client, that answer may be used across all other projects.

Optionally a user selectable accuracy/specificity configuration may be associated with the question priority data. The assessment engine may select the question to be displayed to a user in a specified priority level or higher based on the user selected accuracy setting. Optionally, the user accuracy/specificity configuration may be a document-specific accuracy level that depends on the type of project document being creating. For example, questions with a priority level 5 may be appropriate for a rough Statement of Work (SOW) that needs an estimate of cost. However, questions with a more accurate priority level 7 can be selected for a final version of the SOW document.

Referring next to FIG. 13, there is shown another example user interface diagram 1300. The user interface 1302 may be used by a user to edit/modify a virtual user configuration 1304. The configuration 1304 may include a predefined assessment prompt that the assessment engine can use when requesting assessment of the project initiation data using the LLM system. The user interface 1300 shows the configuration of a client virtual user that can be used to provide simulated responses to question prompts without requiring user interaction with the user interface.

In the example illustrated, user interface 1302 includes a schema field 1306, a save button 1324, and a save and lock button 1326. The save button saves changes to the configuration 1304. The save and lock button 1326 may save the configuration 1304 and prevent editing of the configuration 1304 until the configuration is unlocked.

The schema field 1306 may identify relevant database tables and database connection information that may be used to incorporate client specific data into the operation of the user interface.

The key field 1322 may allow a user to save individual prompts for different virtual user, different clients, or different projects.

Referring next to FIG. 14, there is shown an example user interface 1400. The user interface 1400 may be used by a user to edit/modify a virtual user configuration. The example user interface 1400 show a virtual user configuration for an agency virtual user, as opposed to the client-based representative in FIG. 13.

Referring next to FIG. 15, shown therein is a flowchart of an example method 1500 for providing a user interface to assist in the generation of project initiation data. Method 1500 may be performed by the assessment engine 230 (see e.g. FIG. 2) in order to provide a user interface and assist a user in generating project initiation documents.

At 1502, a persona database is provided at a memory. The persona database can include a plurality of personas and a corresponding plurality of questions.

At 1504, ML-assisted project initiation user interface data can be sent to a user device. The ML-assisted project initiation user interface data can be used by the user device to render a ML-assisted project initiation user interface such as the example user interfaces shown and described herein above. The ML-assisted project initiation user interface can be defined to include at least one virtual representative. Each virtual representative can correspond to one of the personas in the plurality of personas. Each virtual representative can be associated with at least one associated question from the plurality of questions.

At 1506, collected project initiation data can be received from a user at the user device through the ML-assisted project initiation user interface. The collected project initiation data can be received subsequent to presenting a question prompt to the user through the ML-assisted project initiation user interface. The question prompt can include a particular virtual representative and a particular associated question associated with that particular virtual representative.

At 1508, an assessment prompt can be transmitted to a Large Language Model (LLM) system. The assessment prompt can include at least one selected question from the plurality of questions and the collected project initiation data received from the user at 1506.

At 1512, an assessment response can be received from the LLM system in response to the assessment prompt. The assessment response can indicate whether the collected project initiation data is responsive to the at least one selected question.

At 1514, the ML-assisted project initiation user interface can be updated at the processor with at least one unanswered question based on the assessment response.

Optionally, the method may include selecting the plurality of questions from the persona database based on a selected set of personas and a priority metric associated with each question in the plurality of questions.

Optionally, the method may further include: updating, at the processor, the selected plurality of questions from the selected plurality of personas by filtering the questions based on a priority metric.

Optionally, the method may further include: identifying a sub-grouping of questions based on the assessment response, the sub-grouping of questions being related to a particular selected question of the at least one selected question, where the assessment response indicates that further related project initiation data is required relating to the particular selected question and the sub-grouping of related questions is identified to prompt the collected of the further related project initiation data; and updating, at the processor, the ML-assisted project initiation user interface with the sub-grouping of questions.

Optionally, the method may further include: providing, at the memory, a client database comprising at least one client fact, each client fact corresponding to a client identifier; receiving, at the processor, a client selection request comprising a selected client identifier; and wherein the assessment of the document content may comprise the at least one client fact in the client database corresponding to the selected client identifier.

Optionally, the document content may comprise text.

Optionally, the document content may comprise image data and the Large Language Model (LLM) system may comprise a multi-modal model.

Optionally, the method may further include: identifying at least two candidate Large Language Model (LLM) systems; and selecting the Large Language Model (LLM) system from the at least two candidate LLM systems.

Optionally, the method may further include: receiving from the user device, a persona selection request comprising the selected plurality of personas. The assessment of the document content may comprise a selected plurality of questions from the selected plurality of personas.

Referring next to FIG. 16, there is shown a flowchart of another example method 1600 that can be used to provide a user interface and to assist in the generation of project initiation documents. The method 1600 may be performed by the assessment engine 230 (see e.g. FIG. 2) to provide a user interface and to assist in the generation of project initiation documents.

At 1602, a subset of questions that are stored in the persona database may be provided. The subset of questions can include selected questions for a particular project. At 1604, relevant project facts, such as client facts (such as those stored in the vector database in the client database) may be loaded, in addition to the project initiation data submitted by the user 1606 of the project initiation user interface 302 (see e.g. FIG. 3).

The provided question 1602, the relevant project facts 1604, and the project initiation data 1606 may be combined as input to the assessment engine. An assessment may be triggered 1608 based on changes in one of the client facts (such as those stored in the vector database in the client database) may be loaded, in addition to the project initiation data submitted by the user 1606. An assessment may also be triggered by a user manually initiating an assessment, for instance by selecting the assessment button in the user interface.

At 1610, the questions 1602 may be filtered or selected based on the priority identified by the user of the user interface, filtered based on an identified subgrouping of questions in the question hierarchy, and filtered based upon the user selected personas or representatives used for the assessment.

At 1612, the assessment is sent to an LLM system, including the assessment prompt, prompts associated with the user selected representatives, client configuration, and portfolio configuration. This may include, at 1614, selecting the LLM system from many different LLM systems in order to complete the assessment request.

At 1616, if the assessment response identifies that the questions are answered based on the submitted document content, client facts, portfolio facts, or representative/persona configuration, the user interface is updated at 1620. If the assessment response identifies that the submitted document content, client facts, portfolio facts, or representative/persona configuration trigger sub-groupings or branches of the hierarchical question tree, then the sub-grouping of questions is added to the list of questions 1622 and the user interface is updated 1624.

The present invention has been described here by way of example only. Various modification and variations may be made to these exemplary embodiments without departing from the scope of the invention, which is limited only by the appended claims.

All publications, patents and patent applications are herein incorporated by reference in their entirety to the same extent as if each individual publication, patent or patent application was specifically and individually indicated to be incorporated by reference in its entirety.

1. A computer-implemented method for generating an ML-assisted project initiation user interface using a plurality of personas and a corresponding plurality of questions, comprising:
transmitting, to a user device, ML-assisted project initiation user interface data usable at the user device to render a ML-assisted project initiation user interface, the ML-assisted project initiation user interface defined to include at least one virtual representative, each virtual representative corresponding to one of the personas in the plurality of personas and each virtual representative associated with at least one associated question from the plurality of questions;
receiving collected project initiation data from a user at the user device through the ML-assisted project initiation user interface, wherein the collected project initiation data is received subsequent to presenting a question prompt to the user through the ML-assisted project initiation user interface, wherein the question prompt includes a particular virtual representative and a particular associated question associated with that particular virtual representative;
transmitting an assessment prompt to a Large Language Model (LLM) system, wherein the assessment prompt includes at least one selected question from the plurality of questions and the collected project initiation data received from the user;
receiving, an assessment response from the LLM system in response to the assessment prompt, wherein the assessment response indicates whether the collected project initiation data is responsive to the at least one selected question;
updating, at the processor, the ML-assisted project initiation user interface with at least one unanswered question from the plurality of questions based on the assessment response.

2. The method of claim 1, further comprising:
selecting the plurality of questions from the persona database based on a selected set of personas and a priority metric associated with each question in the plurality of questions.

3. The method of claim 2, further comprising:
identifying, at the processor, a sub-grouping of related questions based on the assessment response, the sub-grouping of related questions being related to a particular selected question of the at least one selected question, wherein the assessment response indicates that further related project initiation data is required relating to the particular selected question and the sub-grouping of related questions is identified to prompt the collected of the further related project initiation data; and
updating, at the processor, the ML-assisted project initiation user interface with the sub-grouping of questions.

4. The method of claim 1 wherein the document content comprises text.

5. The method of claim 4 wherein the document content comprises image data and the Large Language Model (LLM) system comprises a multi-modal model.

6. The method of claim 1 further comprising:
identifying at least two candidate Large Language Model (LLM) systems; and
selecting the Large Language Model (LLM) system from the at least two candidate LLM systems.

7. The method of claim 1 further comprising:
receiving, from the user device, a persona selection request comprising the selected plurality of personas.

8. A computer-implemented system for generating an ML-assisted project initiation user interface, comprising:
a memory storing a plurality of personas and a corresponding plurality of questions;
a processor in communication with the memory and a user device, the processor configured to:
transmit, to a user device, ML-assisted project initiation user interface data usable at the user device to render a ML-assisted project initiation user interface, the ML-assisted project initiation user interface defined to include at least one virtual representative, each virtual representative corresponding to one of the personas in the plurality of personas and each virtual representative associated with at least one associated question from the plurality of questions;
receive collected project initiation data from a user at the user device through the ML-assisted project initiation user interface, wherein the collected project initiation data is received subsequent to presenting a question prompt to the user through the ML-assisted project initiation user interface, wherein the question prompt includes a particular virtual representative and a particular associated question associated with that particular virtual representative;
send an assessment prompt to a Large Language Model (LLM) system, wherein the assessment prompt includes at least one selected question from the plurality of questions and the collected project initiation data received from the user;
receive an assessment response from the LLM system in response to the assessment prompt, wherein the assessment response indicates whether the collected project initiation data is responsive to the at least one selected question; and
update the ML-assisted project initiation user interface with at least one unanswered question from the plurality of questions based on the assessment response.

9. The system of claim 8, wherein the processor is further configured to:
select the plurality of questions from the persona database based on a selected set of personas and a priority metric associated with each question in the plurality of questions.

10. The system of claim 9, wherein the processor is further configured to:
identify a sub-grouping of related questions based on the assessment response, the sub-grouping of related questions being related to a particular selected question of the at least one selected question, wherein the assessment response indicates that further related project initiation data is required relating to the particular selected question and the sub-grouping of related questions is identified to prompt the collected of the further related project initiation data; and
update the ML-assisted project initiation user interface with sub-grouping of questions.

11. The system of claim 8 wherein the document content comprises text.

12. The system of claim 11 wherein the document content comprises image data and the Large Language Model (LLM) system comprises a multi-modal model.

13. The system of claim 8 wherein the processor is further configured to:
identify at least two candidate Large Language Model (LLM) systems; and
select the Large Language Model (LLM) system from the at least two candidate LLM systems.

14. The system of claim 8 wherein the processor is further configured to:
receive, a persona selection request comprising the selected plurality of personas.

15. A computer program product for generating an ML-assisted project initiation user interface, the computer program product comprising a non-transitory computer readable medium storing computer-executable instructions wherein when the computer-executable instructions are executed by a processor the instructions cause the processor to perform a method for generating an ML-assisted project initiation user interface using a plurality of personas and a corresponding plurality of questions, wherein the method comprises:
transmitting, to a user device, ML-assisted project initiation user interface data usable at the user device to render a ML-assisted project initiation user interface, the ML-assisted project initiation user interface defined to include at least one virtual representative, each virtual representative corresponding to one of the personas in the plurality of personas and each virtual representative associated with at least one associated question from the plurality of questions;
receiving collected project initiation data from a user at the user device through the ML-assisted project initiation user interface, wherein the collected project initiation data is received subsequent to presenting a question prompt to the user through the ML-assisted project initiation user interface, wherein the question prompt includes a particular virtual representative and a particular associated question associated with that particular virtual representative;
transmitting an assessment prompt to a Large Language Model (LLM) system, wherein the assessment prompt includes at least one selected question from the plurality of questions and the collected project initiation data received from the user;
receiving, an assessment response from the LLM system in response to the assessment prompt, wherein the assessment response indicates whether the collected project initiation data is responsive to the at least one selected question;
updating, at the processor, the ML-assisted project initiation user interface with at least one unanswered question from the plurality of questions based on the assessment response.

16. The computer program product of claim 15, further comprising instructions for configuring a processor to select the plurality of questions from the persona database based on a selected set of personas and a priority metric associated with each question in the plurality of questions.

17. The computer program product of claim 16, further comprising instructions for configuring a processor to
identify a sub-grouping of related questions based on the assessment response, the sub-grouping of related questions being related to a particular selected question of the at least one selected question, wherein the assessment response indicates that further related project initiation data is required relating to the particular selected question and the sub-grouping of related questions is identified to prompt the collected of the further related project initiation data; and
update the ML-assisted project initiation user interface with sub-grouping of questions.

18. The computer program product of claim 15, further comprising instructions for configuring a processor to
identify at least two candidate Large Language Model (LLM) systems; and
select the Large Language Model (LLM) system from the at least two candidate LLM systems.

19. The computer program product of claim 15, further comprising instructions for configuring a processor to receive, a persona selection request comprising the selected plurality of personas.
